(19) United States
(12) Patent Application Publication
(10) Pub. No.: US 2009/0038938 A1
(43) Pub. Date: Feb. 12, 2009

(54) MICROFLUIDIC CENTRAL PROCESSING UNIT AND MICROFLUIDIC SYSTEMS ARCHITECTURE

(75) Inventors: Igor Mezic, Goleta, CA (US); Frederic Bottausci, Santa Barbara, CA (US)

Correspondence Address: GATES & COOPER LLP;HOWARD HUGHES CENTER, 6701 CENTER DRIVE WEST, SUITE 1050, LOS ANGELES, CA, 90045, US

(73) Assignee: The Regents of The University of California, Oakland, CA (US)

(21) Appl. No.: 12/118,343

(22) Filed: May 9, 2008

Related U.S. Application Data
(60) Provisional application No. 60/917,148, filed on May 10, 2007.

(51) Int. Cl. G01N 27/26; B01J 19/08

(52) U.S. Cl. 204/400; 204/242; 204/275.1; 204/277; 204/601

(57) ABSTRACT

A software-driven device named the Microfluidic Central Processing Unit (μfCPU). The device is a chamber encompassing a contiguous physical volume equipped with actuators (electrodes, pressure membranes or other) capable of inducing physical forces on liquids, gases and particles contained in it, for the purpose of performing at least the 5 basic microfluidics operations: mixing, concentration, separation, transport and reaction within one integrated chamber. The device can have one volume where all of the operations are performed or can be spatially divided into several “processing areas” between which there are transport routes enabled by the software-regulated actuation. A device that contains more than one μfCPU employed in parallel or in series or both. A device that is composed of one or more than one μfCPU's and where fluids and particles are transported using a central pump together with integrated micropumps.

### CROSS-REFERENCE TO RELATED APPLICATIONS

This application claims the benefit under 35 U.S.C. Section 119(e) of co-pending and commonly-assigned U.S. Provisional Patent Application Ser. No. 60/917,148 filed on May 10, 2007, by Igor Mezic et al., entitled “MICROFLUIDIC CENTRAL PROCESSING UNIT AND MICROFLUIDIC SYSTEMS ARCHITECTURE,” attorneys' docket number 30794.234-US-P1 (2006-672-1), which application is incorporated by reference herein.

### STATEMENT REGARDING FEDERALLY SPONSORED RESEARCH AND DEVELOPMENT

This invention was made with Government support under Grant No. DMS-0507256 awarded by the NSF. The Government has certain rights in this invention.

### BACKGROUND OF THE INVENTION

1. Field of the Invention

The present invention relates in general to the field of manipulating fluid flow and/or particle motivating force and is related to separation, concentration, transport, reaction and mixing apparatus, method and process. More particularly, the present invention relates to microfluidic devices capable of performing such processes and architecture of systems composed of such devices.

2. Description of the Related Art

(Note: This application references a number of different publications as indicated throughout the specification by one or more reference numbers within brackets, e.g., [x]. A list of these different publications ordered according to these reference numbers can be found below in the section entitled “References.” Each of these publications is incorporated by reference herein.)

The science and art of microfluidics has been advanced substantially since its introduction in designs of inkjet printers [1a, 2a]. A particularly important set of applications of microfluidic technology is within the context of genomics, proteomics and medical diagnostics [3a, 4a]. In this context, a typical problem to be solved using a microfluidic device is that of introducing two or more (bio)chemical species, performing mixing operations for fast binding, separating the product from auxiliary material and transporting the product to the analysis stage where it is concentrated in a smaller volume for enhancement of signal. In fact, enabling such a set of operations at microscale is the basic premise of Micro Total Analysis Systems (μTAS)[5a,6a]. Following the design of large-scale biochemical processing units, separate designs arose for various stages of this process, where mixing, reaction, separation, concentration and detection are performed in separate microchambers or microchannels. This in turn necessitates development of pumps and valves that are integrated into the device at microscale and serve as transport and traffic control devices for shipment of particles and liquids from one component to another. However, the development of efficient pumps and valves has been the outstanding problem for microfluidic device development to date. A possible way to circumvent the necessity of multiple micropumps and microvalves is to design a device in which a basic operation set can be performed based on a software protocol. In fact, the Central Processing Unit of modern computers is just such a device in which different logic and arithmetic operations are performed using different protocols of the basic set of operations—encoded in a software program—that is enabled by hardware [12a]. Conceptually, a cell of a living organism is also such a device, in which physical protocols that lead to a variety of biochemical “products” are performed based on “embedded software” contained in the DNA. Such architectures have advantages of both compactness and rapid processing, since no delays are being caused by pumping for transport from one processing device to another.

Devices using electrokinetic properties (electrophoresis, dielectrophoresis, electroosmosis and electrothermal convection) have been used to manipulate fluids and particles. Electrophoresis is a technique for manipulating components of a mixture of charged molecules (proteins, DNAs, or RNAs) in an electric field within a gel or other support. Under AC electric field, uncharged particles suspended in a dielectric media can be polarized and further manipulated. If the field is spatially inhomogeneous, it exerts a net force on the polarized particle known as dielectrophoretic (DEP) force [1]. This force depends upon the temporal frequency and spatial configuration of the field as well as on the dielectric properties of both the medium and the particles. Single frequency electric fields can be used to transport (e.g using traveling wave dielectrophoresis (twDEP)) and separate particles (using e.g. positive (p-DEP) or negative (n-DEP) dielectrophoresis).

Fluid motion can also be induced by applying an electric field onto a solution. The force driving the fluid thus originates in the bulk (buoyancy, electrothermal effect) or at the interface between the fluid and the device containing the fluid (electroosmosis).

The buoyancy generates a flow because of a density gradient. It can be produced by internal or external heating. An electric field is often used as internal energy source. Applied to a solution, part of the electric energy dissipates in the fluid by Joule effect and locally heats the fluid. Furthermore, local heating creates gradients of conductivity and permittivity. The fluid can then move under the influence of an electrothermal flow [2, 3, 4].

Under certain conditions (material properties, conductivity and permeability of the fluid and the device containing the fluid), ion layers develop at the fluid-surface interface due to chemical associations or dissociations and physical adsorption on or desorption from the solid surface. Ion layers can also be generated at the surface of electrodes where a potential is externally imposed. Applying an electric field with a tangential component to the layers moves the ions which carry the fluid along by viscous force. This process produces a bulk flow [2, 3, 4].

Coupled with an electrohydrodynamic flow, several electrode geometries have been designed as a tool to manipulate fluids and particles. Interdigitated castellated electrodes are, for instance, designed to trap and separate particles [5, 6]. Polynomial electrodes [7], planar electrodes [8, 9], quadripolar electrodes [27] or more complex geometries [10] have also been proposed.

The development here has been enabled by enhanced understanding of electroosmotic and electrothermal flows, negative, positive and travelling wave dielectrophoresis [13a,14a-17a]. Combinations of operations such as concentration and mixing have been achieved [11a, 18a]. Combinations of frequencies has been used to add dielectrophoretic and travelling-wave dielectrophoretic signals to separate cells₁₃. But, to the best of our knowledge, none has yet performed all of the basic operations (separation, concentration, mixing, transport and reaction) inside a single device with ability to perform arbitrary sequences of these basic operations.

### Micro Technology Applied to Biological Problems

A particularly important set of applications of microfluidic technology is within the context of genomics, proteomics and medical diagnostic [3a,4a]. Microscale particle and fluid processing [11-13] improves the way many biological and medical analyses are performed both in research and clinical applications, but there is still a lack of an efficient multipurpose device. As sample volumes used in massive parallel systems become smaller and smaller (micro- to nanoliter or even smaller) it is more challenging to manipulate the fluids since the fluid viscosity dominates any convection. However, multiple reports have shown that micromixing, transport or concentration improves various processes used in life sciences and diagnostics (e.g. hybridization reaction [14-16,17,18]). There are a variety of physical actuations that can be used to perform a single operation. For example, micromixing can be achieved by ultrasonic agitation (the nucleation of bubbles creates small jets that enhance the mixing) [19] or by vortexing or agitating the solution and creating convection [20]. Micromixing can also be produced by surface wave generation [21]. In this context, a typical problem to be solved using a microfluidic device is that of introducing two or more (bio)chemical species, performing mixing operations for fast binding, separating the product from auxiliary material and transporting the product to the analysis stage where it is concentrated in a smaller volume for enhancement of signal. In fact, enabling such a set of operations at microscale is the basic premise of Micro Total Analysis Systems (μTAS) [5a,6a].

What is needed then are central processing units that process fluids and particles using combined fluid flow and/or electrokinetic methods to achieve the basic set of operations (BOS) that we define here to include at least operations of separation (S), concentration (C) transport (T), mixing (M) and reaction (R). What is also needed is a microfluidics system architecture of composing these basic units into a system that avoids excessive use of integrated micropumps and microvalves. The present invention satisfies that need.

### SUMMARY OF THE INVENTION

The present invention discloses a software-driven device called the Microfluidic Central Processing Unit (μfCPU). The device is a chamber with solid or free liquid surface walls (droplet) encompassing a contiguous physical volume equipped with actuating equipment (electrodes, pressure membranes or other) capable of inducing physical forces on liquids, gases and particles contained in it, for the purpose of performing at least the 5 basic microfluidics operations (the Basic Operations Set or BOS): mixing, concentration, separation, transport and reaction within one integrated chamber. The device can have one volume where all of the operations are performed or can be spatially divided into several “processing areas” between which there are transport routes enabled by the software-regulated actuation. Also disclosed is the device that contains more than one μfCPU employed in parallel or in series or both and where part of the fluid supply is provided non-exclusively by a central pumping unit.

Also disclosed is a specific device containing electrodes capable of inducing electrokinetic fluid flow (including electroosmotic and electrothermal) inside vessels (including microplates or well-plates) and inducing electrokinetic forces (positive, negative and traveling wave dielectrophoretic) on fluids and particles contained in fluids. The device is tunable, so that by applying different DC and/or AC voltages, frequencies, phases and time-durations different flow and force effects can be induced and adapted to efficiently manipulate the fluids and particles contained inside the vessel for the purpose of achieving processing composed of one or more operations in BOS, performed in series or in parallel. The device can perform one or more particle manipulation operations.

A Microfluidic Central Processing Unit in accordance with the present invention comprises a chamber, wherein the chamber comprises a plurality of electrodes within a contiguous physical volume, the chamber designed to accept at least one substance selected from the group consisting of liquids, gases, and particles within the chamber, a device, coupled to the plurality of electrodes within the chamber, and a computer, coupled to the device, wherein the computer controls signals used to actuate the plurality of electrodes within the chamber to exert at least one physical force on the substance in the chamber, the actuated electrodes performing at least mixing, concentration, separation, transport and reaction processes within the chamber.

Such a unit further optionally comprises the mixing, concentration, separation, transport and reaction processes being performed in sequence, the contiguous volume being spatially divided into a plurality of processing areas, a plurality of transport routes through the chamber for transporting a plurality of fluids between the plurality of processing areas, the Microfluidic Central Processing Unit being coupled to at least one other Microfluidic Central Processing Unit, the substance being delivered to the plurality of Microfluidic Central Processing Units by a central pump, the computer being further coupled directly to the chamber, and the computer detecting at least one of an optical, electrochemical, thermal, or mechanical reaction within the chamber of the Microfluidic Central Processing Unit.

Another unit in accordance with the present invention comprises chamber means for accepting at least one substance, the chamber means having a contiguous physical volume and comprising a plurality of electrodes within the contiguous physical volume, the at least one substance selected from the group consisting of liquids, gases, and particles within the chamber, device means, coupled to the plurality of electrodes within the chamber, for delivering electrical signals to the plurality of electrodes, and processing means, coupled to the device, for generating signals to control the device means delivery of electrical signals to the plurality of electrodes, wherein the plurality of electrodes exert at least one physical force on the substance in the chamber, the actuated electrodes performing at least mixing, concentration, separation, transport and reaction processes within the chamber.

Such a unit further optionally comprises the mixing, concentration, separation, transport and reaction processes being performed in sequence, the contiguous volume being spatially divided into a plurality of processing areas, a plurality of routing means through the chamber means for transporting a plurality of fluids between the plurality of processing areas, the Microfluidic Central Processing Unit being coupled to at least one other Microfluidic Central Processing Unit, the substance being delivered to the plurality of Microfluidic Central Processing Units by a central pump, the processing means being further coupled directly to the chamber means, and the processing means further comprises detection means for detecting at least one of an optical, electrochemical, thermal, or mechanical reaction within the chamber means.

### BRIEF DESCRIPTION OF THE DRAWINGS

Referring now to the drawings in which like reference numbers represent corresponding parts throughout:

FIG. 1. a) Physical realization of the set of interdigitated electrodes that serve as actuators for one (but not the only) embodiment of a μfCPU, in this case enclosed inside a channel. The processing volume can be within channel enclosure and without channel enclosure (droplet on top of electrodes). b) The interdigitated electrode array from the top. On each of the electrodes an electric field potential can be prescribed. c) Control of sets of 4 electrodes, where phases between the electrodes are shown. They can be 90 degrees or different. d) Potential needed to induce traveling wave dielectrophoresis.

FIG. 2. Force and flow fields for manipulations of particles and liquids in the embodiment of a μfCPU shown in FIG. 1: a) n-DEP field in gravity b) p-DEP field c) induced charge electroosmotic flow, upwelling at the electrode center d) electrothermal flow, upwelling between the electrodes. e) twDEP field, transport towards right. f) twDEP field, transport towards left.

FIG. 3. One example of the performance of the μfCPU involving multiple operations in BOS: Time sequence of the particles transport (a-d) and mixing (e-f) inside a droplet. The time between the pictures is 10 seconds. Image (a) shows the separation between the deionized water (black part) and the particle solution (bright) before the electric field is applied. Image (b) was taken 5.7 s after the traveling wave has been applied (9 KHz, 13Vpp with a phase of 90 degrees between the electrodes). The particles move in the direction of the wave (toward the right on the picture) due to twDEP and some advection generated by electroosmosis. Images (c-d) show some bright vertical bands because some particles were trapped at the electrodes edge during the transport due to the p-DEP. Image (e) was taken 2.9 s after the AC signal for mixing has been applied. Once the particles are distributed over the electrodes, the transport AC signal is replaced by a new pulsed AC signal. The pulsed signal is a combination of the transport signal and a perturbation signal. It has a duty cycle of 50% (during a period, for 0.5 s, the signal is 9 KHz, 13Vpp then for 0.5 s the signal is 9 KHz+100 Hz, 63Vpp). The flow is strongly unsteady mixing the particles in solution.

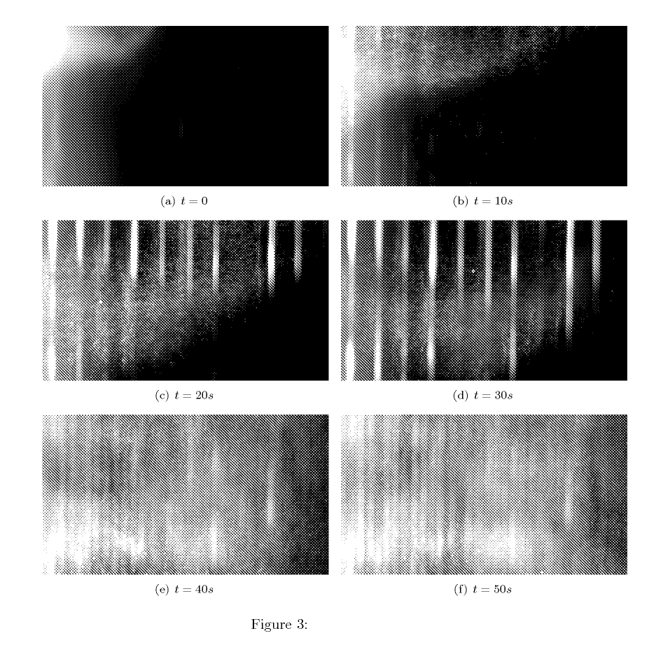

Once the particles are dispersed in the solution, the signal is stopped and the Brownian motion continue to homogenize the solution. Image (f) shows the solution 6.6 s after the signal has been stopped.

FIG. 4. One example of the performance of the μfCPU involving multiple operations in BOS: Time sequence of the particles solution evolution using the interdigitated electrodes device. From initial condition (a), to separation (b) and to mixing (c). The brighter dots are the 1.9 micron particles and the small dots are the 0.71 microns particles. Blurred spots are big particles above the focal plane. Picture (b) shows the solution 1.4 s after the AC signal (2 MHz+100 KHZ, 38Vpp) was applied to separate the particles. The differential n-DEP effect pushed the bigger particles away from the electrodes. They appear blurred because they are above the focus plane while the 0.71 micron particles are still visible close to the electrodes (small dots on the picture). Note that the two bright particles on the upper side of the picture are 1.9 micron particles chemically bound to the electrodes surface.

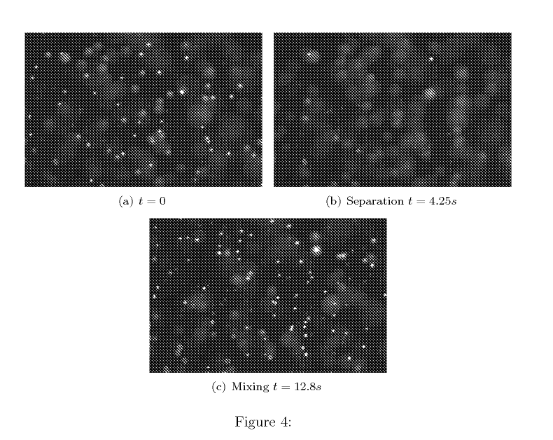

Image (c) shows the particles in solution 1.4 s after the pulsed AC signal (100 KHz+1 KHz, 32Vpp) has been applied. The pulsed signal had a duty cycle of 50% (during a period, for 0.5 s, the signal was 0 then for 0.5 s the signal as 100 KHz+1 KHz, 32Vpp).

FIG. 5. One example of the performance of the μfCPU involving multiple operations in BOS: Use of electrothermal flow to induce mixing [3] and efficiently perform reaction using AttoPhos solution that becomes more fluorescent when in contact with the calf intestinal alkaline phosphatase (CIAP) enzyme. We call this reaction the AP reaction. This type of reaction is typically the last step in ELISA assays. Time sequence of the AP reaction evolution without mixing (a-c) and with mixing (d-f). The time between each image is 39 seconds. Pictures (a and d) show the initial condition just after the droplet of 0.5 μl of AP has been brought in contact with the CIAP. Pictures (b and c) show the intensity evolution of the reaction when no mixing is applied. Pictures (e and f) show the intensity evolution when mixing is applied for 50 s. The mixing is generated by applying a continuous AC signal (1 MHz, 70Vpp) for 50 s after the two solutions have been in contact. The bands visible on the picture (f) are the titanium electrodes. The figure (g) shows a comparison of the intensity evolution when the reaction occurs only by diffusion (blue) and with mixing (red).

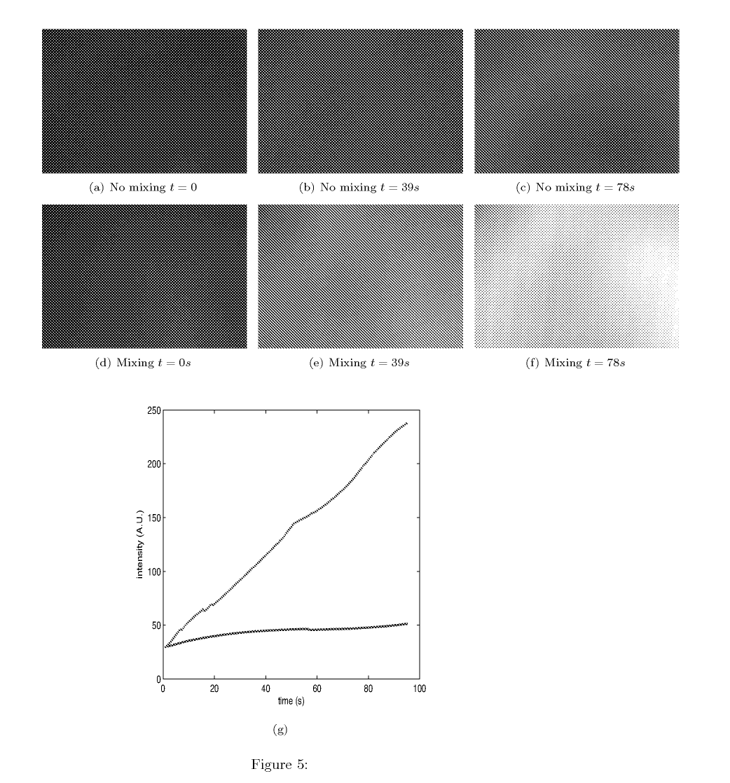

FIG. 6. A schematic of claimed basic microfluidics system architecture: CP stands for “Central Pump”, IP stands for “Integrated Pump”, μfCPU stands for “Microfluidic Central Processing Unit”. 1 or more μfCPU elements are supplied by liquids and particles using a central (possibly macroscale) pump. Integrated pumps can also be used locally where needed. μfCPU units are connected in series or in parallel and arrows indicate flux of material (fluids and particles) between central pump and μfCPU units, and between different μfCPU unit. Each μfCPU unit can perform the set of basic operations that involves at least the minimal BOS: separation, concentration, transport, mixing and reaction.

FIG. 7 is an exemplary computer hardware and software environment used to implement one or more embodiments of the invention.

FIG. 8 illustrates an embodiment of system in accordance with the present invention.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Overview

Current designs for Lab-on-a-Chip applications consist of a variety of separate microfluidic chambers and channels for functions such as concentration, separation, reaction and mixing of bioparticles in liquids [7a-10a]. Here we advance an alternative concept, named μfCPU, the Microfluidic Central Processing Unit, where the key microfluidic operations are performed within a single enclosure, using software-based inputs rather than physical hardware changes, thus emulating the role of the Central Processing Unit in computers and cells in living organisms. The impact of the manipulation of fluids and/or particles induced by electric fields is described theoretically and experimentally herein. By means of a microfluidic device comprising of actuators capable of particle manipulations including concentration, separation, transport or mixing using electrokinetic, electroosmotic, electrothermal or other forces and properties the basic microfluidics operations and their various combinations can be performed within one integrated chamber that has solid of free surface walls (liquid droplet).

We define the μfCPU to be a microfluidic device capable of receiving liquids, gases and particulate species and performing at least the following basic operations on them: bulk transport (T), mixing (M), concentration (C), reaction (R) and separation (S) within a single, contiguous volume. We call the set T, M, C, R, S the Basic Operation Set (BOS). The basic operations are dictated by software programs described below, where signals of various shapes, spatial distribution and time durations generate physical fields such as electromagnetic fields and fluid flows that move liquids and particulate matter according to a specified subset of basic operations in order to achieve a desired output. For example, two species, A and B that are input to the processing chamber in a bulk together with another species C are mixed, react to produce the product P according to A+B=P and separated from C to produce output of pure P that is to be concentrated at the imaging location in the chamber. The associated protocol of operations is [M,R,S,C]. For the physical realization of such a device, certain physical requirements need to be met. The range of electric forces and fluid flows generated in the μfCPU device must be such that the system is controllable for the operations set needed. Controllability means that all the necessary operations in BOS can be performed for a broad range of particles and fluids of interest in microfluidics.

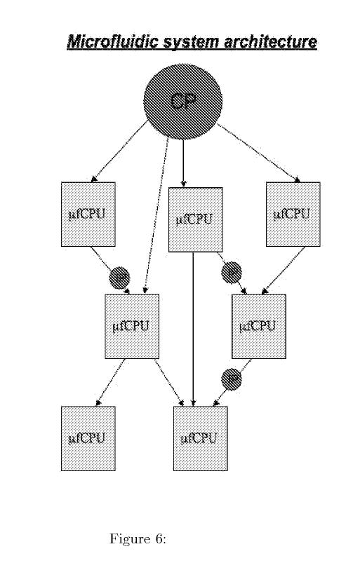

A device that contains more than one, not necessarily equal, μfCPU employed in parallel or in series or both and where part of the fluid supply is provided non-exclusively by a central pumping unit is disclosed here. A schematic of the claimed basic microfluidics system architecture is shown in FIG. 6: CP stands for “Central Pump”, IP stands for “Integrated Pump”, μfCPU stands for “Microfluidic Central Processing Unit”. One or more μfCPU elements are supplied by liquids and particles using a central (possibly macroscale) pump. Integrated pumps can also be used locally where needed. μfCPU units are connected in series or in parallel and arrows indicate flux of material (fluids and particles) between central pump and μfCPU units, and between different μfCPU unit. Each μfCPU unit can perform the set of basic operations that involves at least the minimal BOS: separation, concentration, transport, mixing and reaction.

We also disclose a device that contains more than one, not necessarily equal, μfCPU employed in parallel or in series or both and where pumping is provided by integrated micropumps. Each μfCPU unit can perform the set of basic operations that involves at least the minimal BOS: separation, concentration, transport, mixing and reaction.

This invention could be used, for example, to improve speed and efficiency of high throughput screening assays. Electrokinetic micromixing improves the time and reliability for protein expression by rapidly homogenizing the small volume solution. Current methods require extensive human or robotic operations and generally lack the required sensitivity to meet reliability testing standards. Other possible applications could be the separation and detection of small populations of pre-cancerous cells from body fluids (blood, sputum, urine) or the concentration of DNA particles inside a Polymerase Chain Reaction (PCR) apparatus for improved DNA detection or various ELISA assays.

### Technical Description

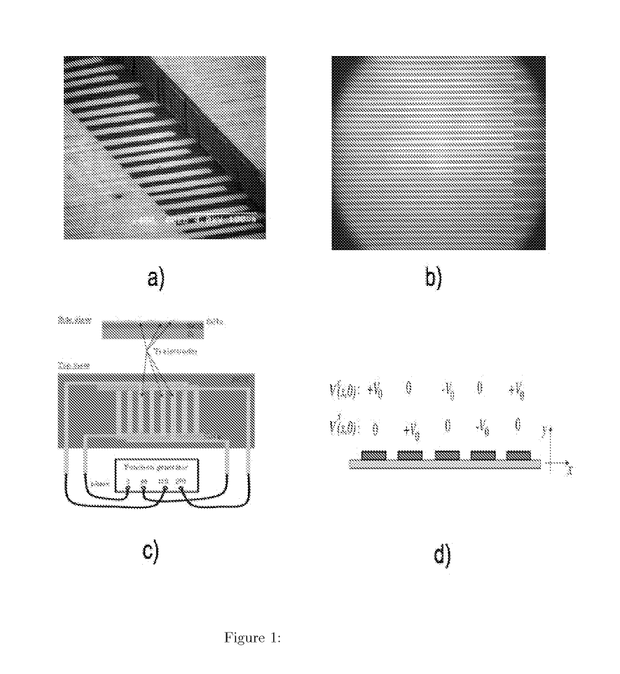

The present invention discloses a software-driven device called the Microfluidic Central Processing Unit (μfCPU). The device is a chamber encompassing a contiguous physical volume equipped with actuating equipment (electrodes, pressure membranes or other) capable of inducing physical forces on liquids, gases and particles contained in it, for the purpose of performing at least the 5 basic microfluidics operations: mixing, concentration, separation, transport and reaction within one integrated chamber. To elucidate this, let us concentrate on the device [11a] shown in FIG. 1. In the FIG. 1a) we show the physical realization of the set of interdigitated electrodes that serve as actuators for our realization of a μfCPU, in this case enclosed inside a channel. We have performed experiments both within channel enclosure and without channel enclosure (droplet on top of electrodes). In FIG. 1b) we show the interdigitated electrodes from the top. On each of the electrodes we can prescribe an electric field potential. In principle, every electrode could be addressed independently, but in our experiments for the purpose of inducing travelling waves we controlled separately sets of 4 electrodes, as shown in FIG. 1 c), where phases between the electrodes are shown to be 90 degrees. In FIG. 1d) we show schematically the potential needed to induce traveling wave dielectrophoresis.

Electric fields induce a force on charged particles in solutions, moving the particles towards either the cathode or the anode depending on the sign of the charged particles [22]. Such a particle motion in liquid phase is called electrophoresis. If the particle is uncharged, applying AC-electric field to the medium containing the particles creates a dipole on the particles. The orientation of the dipole depends on the conductivity and permittivity of both the particles and the medium. For dielectric particles, the expression of the time average force is given by

[symbol]

F_{DEP} [symbol] =2πa³εₘRe[K(ω)] V̅|E|²

where E is the rms electric field, a is the particle radius, ω is the angular field frequency, and Re[z] indicates the real part of the complex number z. The factor K(ω) is a measure of the effective polarizability of the particle, known as the Clausius-Mossotti factor, given by

K(ω)=(ε*ₚ−ε*ₘ)/(ε*ₚ+2ε*ₘ)

where ε*ₚ and ε*ₘ are the complex permittivities of the particle and the medium, respectively. The complex permittivity is defined as ε*=ε−i(σ/ω), where i=\sqrt{−1}, ε is the permittivity, and σ is the conductivity.

The particles submitted to a non uniform electric field will move toward or away the high electric field region depending on the sign of Re[K(ω)]. The motion of the particles is called dielectrophoresis.

Electrophoresis and dielectrophoresis are two major subjects in particle separation and transport. For separation purposes, let's consider a common case where two types of particles are present in the solution.

Separation occurs when there is a frequency ωₛ for which Re[K(ω)] takes a different sign for each particle type. For particles having close properties ωₛ might be impossible to apply experimentally. In that case [23] have shown that two superposed AC-electric fields with two different frequencies ωₛ₁ and ωₛ₂ enables the particle separation. ωₛ₁ and ωₛ₂ being two frequencies for which each particle type has a Clausius-Mossotti factor of opposite sign.

Consider a simple but commonly used configuration of an electrode array for which a closed-form solution of the electric field and the DEP force was derived in [23]. It is comprised of a periodic array of long parallel micro-electrodes. Each electrode submitted to an AC-electric field with a defined phase difference with their neighbors will simultaneously separate and transport the particles through the system [23]. The process is named traveling wave dielectrophoresis.

Electric fields induce fluid and/or particle motions through several electrohydrodynamic, electrophoretic or dielectrophoretic effects. Among all the effects the flow is submitted to, the most important in microelectrode devices are electrothermal convection and electroosmosis. The former appears to be due to a non-uniform Joule heating of the fluid which leads to gradients of its permittivity and conductivity. The applied electric fields acting on the permittivity and conductivity gradients generate electrical body forces that induce the flow [13]. The latter is caused by electrical stresses in the diffuse double layer of charges accumulated above the electrodes (AC-electroosmosis) [14] or at the walls (electroosmosis) [24]. These stresses result in a rapidly varying fluid velocity profile in the diffuse double layer, going from zero at the wall to a finite value just outside the double layer. Whether electrothermal or AC-electroosmotic flows dominate the motion of fluid in the device depends mainly on the frequency of the applied electric field and the conductivity of the medium, AC-electroosmosis being dominant at a frequency range several orders of magnitude below the charge relaxation frequency (ω_{c}≈σ/ε) for low conductivity media.

If the applied frequency is chosen carefully, the induced effects will most affect the fluid flow and produce efficient mixing, for instance. Using multifrequency electric field signals [8] will, most of the time, improve even more the flow manipulation.

Dielectrophoresis and fluid flow precisely combined make possible the manipulation of submicron particles [25]. For a careful choice of the applied frequency, the electrohydrodynamically induced fluid flows will have a minimal effect but will be determinant in the DEP manipulation and/or separation of submicron particles. It has been shown that the induced dynamical properties can be creatively used as a mechanism to control micro or submicron particles.

Experiments and numerical simulations of the coupled electro-thermo-hydrodynamic problem in devices with interdigitated arrays of electrodes [12, 13, 14] or electrode poles [26] show that both electrothermal and AC-electroosmotic flows consist of convective rolls centered at the electrode edges and provide good estimates for their strength and frequency dependence. Near the electrodes, the fluid velocity u₀ ranges from 1 to 1000 μm.s⁻¹ decaying exponentially with the transversal distance to the electrodes.

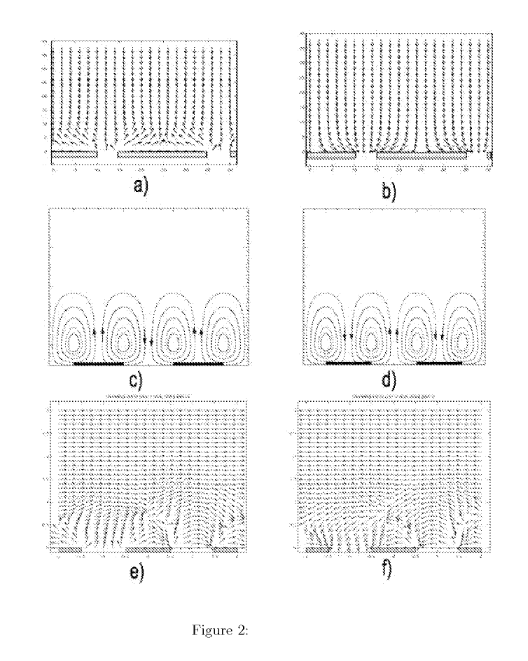

In a device of characteristic length d=150 μm, fluid viscosity v=10⁻⁶m²s⁻¹, conductivity σ=0.6 S.m⁻¹ with AC-electric field of 530V/cm, the maximum flow velocity is measured to be 150 μm.s⁻¹ [FIG. 2].

The electric field induced heating inside the solution induces buoyancy flow effects. These are caused by gravity acting on nonhomogeneities in densities inside the liquid solution to induce flow. These are possibly used in the device in conjunction with electrokinetic/electrothermal effects to provide mixing, concentration, separation and transport effects.

The possibility of inducing all of these force fields in the device implies that an individual particle is moving in specific device shown in FIG. 1 according to the stochastic differential equation

$$dx = {α}_{n} ( t ) {F}_{n} ( x , ω ) {α}_{P} ( t ) {F}_{P} ( x , ω ) + {α}_{eo} ( t ) {v}_{eo} ( x , ω ) + {α}_{et} ( t ) {v}_{et} ( x , ω ) + {α}_{twl} ( t ) {F}_{twl} ( x , ω ) + {α}_{twr} ( t ) {F}_{twr} ( x , ω ) - ( {ρ}_{p} - {ρ}_{m} ) \cdot \frac{2 {a}^{2}}{9 η} + d {W}_{t} .$$

where Fₙ is the n-DEP force on a particle, Fₚ is the p-DEP force on a particle, vₑₒ is the electroosmotic velocity field, vₑₜ is the electrothermal velocity field, F_{twl} is the left-pointing traveling wave force, F_{twr} is the right-pointing traveling wave force, ρₚ and ρₘ are the particle and medium density, a is the particle radius, η fluid viscosity and dWt is Brownian motion. Using these fields, universal operation can be achieved.

Pressure-driven flows can be used to carry fluids and particles from one basic μfCPU unit to another or from the central pump to μCPU units, as shown in FIG. 6. Each μfCPU device can be separated into more than one volume where a separate operation, driven by software commands is performed.

Mixing can be achieved in a variety of ways by using convective flows shown in figures c,d). Time-dependent pulsing leads to good mixing properties. Thus, selecting a frequency vector ω such that Fᵢ=0 for all i but velocity field nonzero, with an oscillatory protocol αⱼj=eo or j=et leads to effective mixing based on chaotic advection. α's for convective flow can be chosen to be a square wave (on-off with prespecified time intervals) since such mixing protocols have certain optimality properties. The possible mixing protocol can be graphically represented as

[symbol]

−−)×n=□.

where convective circles stand for convective electroosmotic or electrothermal fluid flow, n stands for time of repeat of the basic process and the box represents a uniform concentration of particles in the volume.

Concentration can be achieved by a combination of convective flow fields shown in FIGS. 2 c) and d) with positive or negative dielectrophoresis, shown in FIGS. 2a) and b). The operation that leads to it can be represented for example by

[symbol]

∪↑=\dot{□}.

Separation can be achieved by a combination of force fields shown in FIGS. 2a) and b) with positive or negative dielectrophoresis. Separation is not a unary operation—it can act on n particles simultaneously. For two particle types A,B we graphically represent it by e.g.

·↓_{A}∪↑_{B}=·□·

Transport in the horizontal direction inside a μfCPU device is mainly achieved by twDEP fields shown in FIGS. 2e,f). Note that, again, twDEP will act differently on different particles and thus we can achieve separation in the horizontal direction using twDEP. In fact, a combination of twDEP and n-DEP acting on an specific particle type can send a distribution of such particles in the direction of a pre-specified vector. twDEP is denoted by left and right arrows in software programs for μfCPU.

Reaction is not commonly affected by actuation described here (although the nonhomogeneous electric fields do change the particle charge structure, so potential changes to reaction rate are possible). Of course, reaction benefits from enhanced mixing or concentration and in this sense reaction is already a compound operation where it arises as a consequence of another. For more complex designs reaction can be performed at specific spatial locations, but in our experiments it was performed in the bulk. However, reaction is one of the BOS operations and we will denote it by R in our programs.

Having these basic operations functional in a device, a large set of programs can be executed, specified by their frequency vector and duration. In fact, a program

_{A}→·↓_{A}·←_{B}· [symbol] −−∪R)×10·↑_{A}∪↓_{P}·_{A}→

where periods are separating different operations could be used to bring in antibody A from the left, concentrate it to electrode edges using pDEP, bring in antigen B from the right input to the device, mix them, have a reaction take place and then separate bound from unbound material. In “machine language” we describe each operation by ((ω₁, . . . , ωₙ), τ, φ, V ) for frequencies, duration time, phases and voltage applied. Thus “higher level” set of instructions would be compiled as

(ω₁, τ₁, 90, V₁) [→ for time τ₁, at phase 90 degrees, with voltage V₁], (3)

(ω₂, τ₂, 0, V₂) [↓ for time τ₂, at phase 0 degrees, with voltage V₂], (4)

(ω₂, τ₃, 90, V₃) [← for time τ₃, at phase 90 degrees, with voltage V₃], (5)

Comment: next repeat the mixing procedure that consists of pulses of electroosmotic flow, n times.

for i=1:n, (6)

(ω₃, τ₄, 0, V₄) [symbol] −− for time τ₄, at phase 0 degrees, with voltage V₄], (7)

end (8)

(ω{ω₅, ω₆}, τ₅, 0, V₅) [·□· for time τ₅, at phase 0 degrees, at voltage V₄] (9)

### Hardware Environment

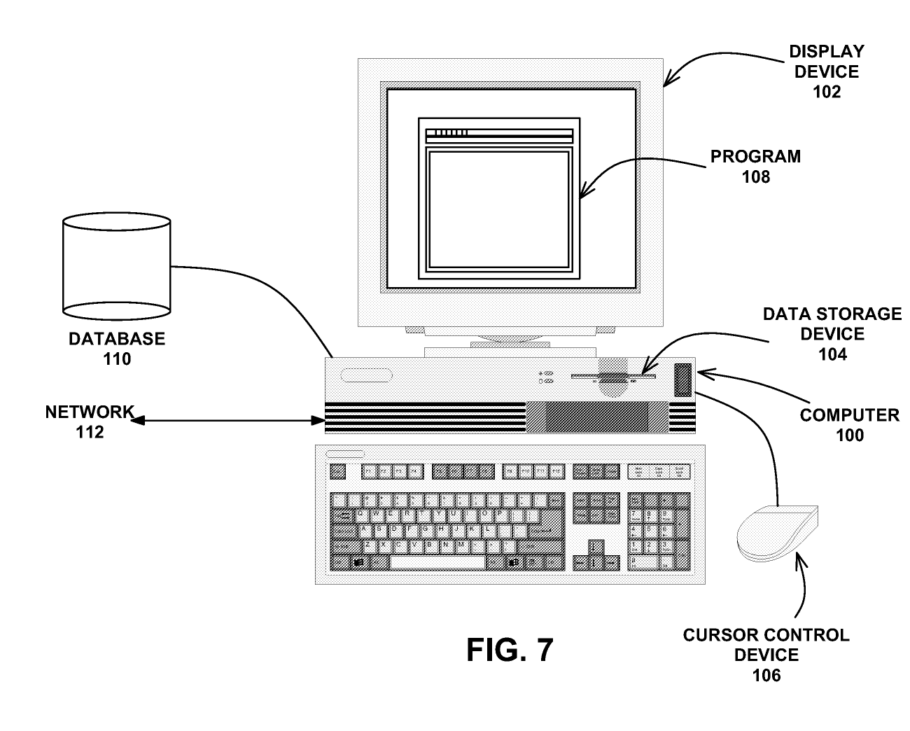

FIG. 7 is an exemplary computer hardware and software environment used to implement one or more embodiments of the invention. Embodiments of the invention are typically implemented using a computer 100, which generally includes, inter alia, a display device 102, data storage devices 104, cursor control devices 106, and other devices. Those skilled in the art will recognize that any combination of the above components, or any number of different components, peripherals, and other devices, may be used with the computer 100.

One or more embodiments of the invention are implemented by a computer-implemented microfluidics control program 108, wherein the program 108 is represented by a window displayed on the display device 102. Generally, the program 108 comprises logic and/or data embodied in or readable from a device, media, carrier, or signal, e.g., one or more fixed and/or removable data storage devices 104 connected directly or indirectly to the computer 100, one or more remote devices coupled to the computer 100 via a data communications device, etc. Further, the program 108 may utilize a database 110 such as a spatial database.

Computer 100 may also be connected to other computers 100 (e.g., a client or server computer) via network 112 comprising the Internet, LANs (local area network), WANs (wide area network), or the like. Further, database 110 may be integrated within computer 100 or may be located across network 112 on another computer 100 or accessible device.

Those skilled in the art will recognize that the exemplary environment illustrated in FIG. 1 is not intended to limit the present invention. Indeed, those skilled in the art will recognize that other alternative environments may be used without departing from the scope of the present invention.

### System Diagram

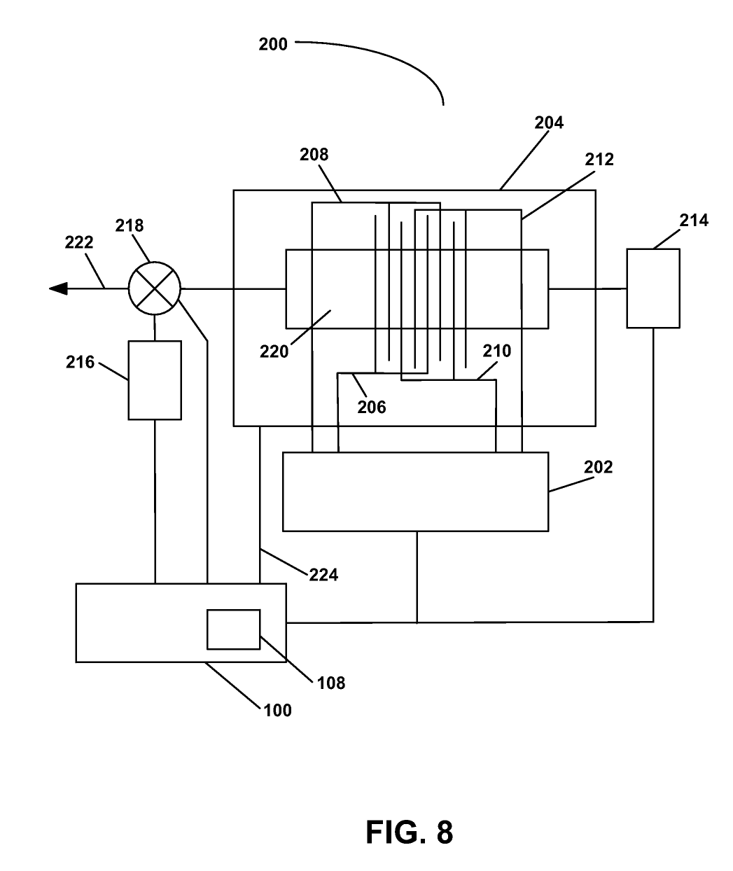

FIG. 8 illustrates an embodiment of system in accordance with the present invention.

System 200 is shown, with computer 100 connected to a waveform generator 202, or other device, that energizes the μfCPU device 204, namely, the electrodes 206-212, as fluids or fluidic solutions are placed in the μfCPU device 204. Although four pairs of electrodes 206-212 are shown, a larger or smaller number of electrodes 206-212 can be used without departing from the scope of the present invention.

Within μfCPU device 204, fluids or fluidic solutions are manipulated by placing various AC, DC, or AC and DC waveforms on the various electrodes 206-212. Electrodes 206-212 can take various shapes, or be made of different materials, to better manipulate the fluids placed in μfCPU device 204. For example, and not by way of limitation, blood may react better to electrodes 206-212 that are planar, while other fluids may react better to electrodes 206-212 that are more cylindrical in nature. Similarly, different materials may provide better or more uniform electric fields for the manipulations, depending on the specific application for the μfCPU device 204.

Program 108 is used to control computer 100, which, in turn, controls the waveform generator 202 to perform the desired manipulation of fluid within μfCPU device 204. Further, computer 100, via program 108 or another program, can control other devices, such as pumps 214 and 216, and valve 218, to control the movement of fluid through channel 220 (also referred to as the chamber 220). For example, computer 100 controls the introduction of fluid from pump 214 to channel 220, manipulates the fluid through at least one of separation, concentration, mixing, transport, and reaction within channel 200, and transports the fluid through channel 220. Computer 218 then opens valve 218, and transports the fluid from channel 220 to line 222 for further processing or collection, and, if desired, mixes an additional fluid from pump 216 with the fluid previously processed in channel 220. Line 222 can be connected to another μfCPU device 204 which can be controlled by computer 100 or another computer 100 for a different set of manipulations as desired. Pumps 214-216 can be coupled to multiple μfCPU devices 204 such that a single computer 100 can control the delivery of the fluid or other substance to another μfCPU device 204 as desired, either in serial or parallel fashion.

Further, computer 100 can be coupled directly to μfCPU device 204, such that thermal, electrical, or mechanical excitations can be measured directly by computer 100 to more precisely control μfCPU device 204. For example, μfCPU device 204 can be loaded with a fluid and heated by a heater. A temperature probe can be coupled to channel 200 to determine the temperature of the fluid, and, when the fluid reaches a certain temperature, computer 100 can then command device 202, or pumps 214-216, or some other device, to perform a manipulation on the fluid, e.g., mixing the fluid with another fluid, begin a reaction, etc. Mechanical excitations can be detected through microcantilevers, or accelerometers, or vibration sensors, or other techniques. Optical excitations can be detected through photodetectors or other detection equipment. Computer 100 can also receive information directly from μfCPU device 204, or other devices in the system 200, through device 202 if desired. So, for example, pumps 214, 216, and 218 can all be coupled to device 202, and controlled through computer 100 if desired. The direct connections from μfCPU device 204 and pumps 214 and 216 can be made through any number of intermediate devices 202 as desired by the system 200 designers without departing from the scope of the present invention.

### REFERENCES

The following references are incorporated by reference herein:
1a. Squires, T. M. & Quake, S. R. Microfluidics: Fluid physics at the nanoliter scale. Reviews of Modern Physics 77, 977-1026 (2005).
2a. Whitesides, G. M. The origin and future of microfluidics. Nature 442, 368-373 (2006).
3a. Yager, P. et al. Microfluidic diagnostic technologies for global public health. Nature 442, 412-418 (2006).
4a. Chin, C. D., Linderb, V. & Sia, S. K. Lab-on-a-chip devices for global health: Past studies and future opportunities. lab on a Chip 7, 41-57 (2007).
5a. Manz, A., Graber, N. & Widmer, H. M. Miniaturized total chemical-analysis systems—a novel concept for chemical sensing. Sensors and Actuators B-Chemical 1, 1-6 (1990).
6a. Dittrich, P. S., Tachikawa, K. & Manz, A. Scaling and the design of miniaturized chemical analysis systems. Nature 442, 374-380 (2006).
7a. Liu, R. H., Yang, J., Lenigk, R., Bonanno, J. & Grodzinski, P. Self-contained, fully integrated biochip for sample preparation, polymerase chain reaction amplification, and dna microarray detection. Analytical Chemistry 76, 1824-1831 (2004).
8a. Wang, J. et al. Integrated microfluidics for parallel screening of an in situ click chemistry library. Lab-on-a-Chip 45, 5276-5281 (2006).
9a. Kartalov, E. P. et al. High-throughput multi-antigen microfluidic fluorescence immunoassays. Biotechniques 40, 85-90 (2006).
10a. Janasek, D., Franzke, J. & Manz, A. Scaling and the design of miniaturized chemical-analysis systems. Nature 442, 374-380 (2006).
11a. Tuval, I. et al. Control of particles in micro-electrode devices. Physical Review Letters 95, 236002 (2005).
12a. von Neumman, J. First draft of a report on the EDVAC (1945). Report on the Contract No. W-670-ORD-4926, Between the United States Army Ordnance Department and the University of Pennsylvania Moore School of Electrical Engineering.
13a. Pethig, R., Talary, M. S. & Lee, R. S. Enhancing traveling-wave dielectrophoresis with signal superposition. Measurement Science and Technology 3, 439-445 (1992).
14a. Ramos, A., Morgan, H., Green, H. & Castellanos, A. AC electrokinetics: a review of forces in microelectrode structures. J. Phys. D: Appl. Phys. 31, 2238-2353 (1998).
15a. Ramos, A., Morgan, H., Green, N. G. & Castellanos, A. AC electric-field-induced fluid flow in microelectrodes. Journal of Colloid and Interface Science 217, 420-422 (1999).
16a. Squires, T. & Bazant, M. Z. Induced-charge electro-osmosis. Journal of Fluid Mechanics 509, 217-152 (2004).
17a. Kilic, M. S., Bazant, M. Z. & Adjari, A. Steric effects in the dynamics of electrolytes at large applied voltages. parts I and II. 75, 021502 (2007). Physical Review Letters.
18a. Gadish, N. & Voldman, J. High-throughput positive-dielectrophoretic bioparticle microconcentrator. Analytical Chemistry 78, 7870-7876 (2006).
1. H. A. Pohl, Dielectrophoresis (Cambridge University Press, 1978).
2. N. G. Green, A. Ramos, A. Gonzalez, H. Morgan, A. Castellanos, Phys. Rev. E 61, 4011 (2000).
3. A. Ramos, H. Morgan, N. G. Green, A. Castellanos, J. Phys. D: Appl. Phys. 31, 2338 (1998).
4. N. G. Green, A. Ramos, A. Gonzalez, H. Morgan, A. Castellanos, Phys. Rev. E 66, 026305 (2002).
5. PETHIG R, HUANG Y, WANG X B, BURT J P H, “POSITIVE AND NEGATIVE DIELECTROPHORETIC COLLECTION OF COLLOIDAL PARTICLES USING INTERDIGITATED CASTELLATED MICROELECTRODES,” Journal of Physics D-Applied Physics 25 (5): 881-888 May 14, 1992.
6. Arnold W M, Franich N R, Cell isolation and growth in electric-field defined micro-wells, APPLIED PHYSICS 6 (3): 371-374 JUN 2006
7. H. Morgan, M. P. Hughes, and N. G. Green, “Separation of submicron bioparticles by dielectrophoresis,” Biophysical Journal 77 (1999) 516-525.
8. I. Tuval, I. Mezic, F. Bottausci, Y. T. Zhang, N. C MacDonald and O. Piro, Control of particles in microelectrode devices, Physical Review Letters 95(23) December 2005
9. J. Suchiro, and R. Pethig, “The dielectrophoretic movement and positioning of a biological cell using a three-dimensional grid electrode system,” Journal of Physics D: Applied Physics 31 (1998) 3298-3305.
10. T. Müller, G. Gradl, S. Howitz, S. Shirley, T. Schnell, and G. Fuhr, A 3-D microelectrode system for handling and caging single cells and particles, Biosensors & Bioelectronics 14 (1999) 247-256.
11. Marshall A and Hodgson J 1998 DNA chips: an array of possibilities Nat. Biotechnol. 16 27.
12. Southern E, Mir K and Shchepinov M 1999Molecular interactions on microarrays Nat. Genet. 21 (Suppl.) 5-9.
13. Xiang C C and Chen Y 2000 Biotechnol. Adv. 18 35-46.
14. Liu J, Williams B A, Gwirtz R M, Wold B J, Quake S, ANGEWANDTE CHEMIE-INTERNATIONAL EDITION 45 (22): 3618-3623 2006.
15. Yuen P K, Li G S, Bao Y J, Muller U R, Microfluidic devices for fluidic circulation and mixing improve hybridization signal intensity on DNA arrays LAB ON A CHIP 3 (1): 46-50 2003.
16. Sasakura Y, Kanda K, Fukuzono S, Microarray techniques for more rapid protein quantification: Use of single spot multiplex analysis and a vibration reaction unit, ANALYTICA CHIMICA ACTA 564 (1): 53-58 Mar. 30, 2006.
17. F Fixe, H M Branz, N Louro, V Chul, D M F Prazeres and J P Conde, Electric-field assisted immobilization and hybridization of DNA oligomers on thin-film microchips, Nanotechnology 16 (2005) 2061-2071.
18. Sigurdson M, Wang D Z, Meinhart C D, Electrothermal stirring for heterogeneous immunoassays, LAB ON A CHIP 5 (12): 1366-1373 2005.
19. Robin H. Liu, Ralf Lenigk, Piotr Grodzinski, Acoustic micromixer for enhancement of DNA biochip systems J. Microlith., Microfab., Microsyst., Vol. 2 No. 3, July 2003 179.
20. J Vanderhoeven, K, Pappaert, B, Dutta, P. V, Hummelen and G. Desmet DNA Microarray Enhancement Using a Continuously and Discontinuously Rotating Microchamber, Anal. Chem. 2005, 77, 4474-4480.
21. M. Hartmann a, A. Toeglb, R. Kirchner b, M. F. Templin a, T. O. Joos, Increasing robustness and sensitivity of protein microarrays through microagitation and automation Analytica Chimica Acta 564 (2006) 66-73.
22. D. Li, electrokinetics in microfluidics, Elsevier Academic Boston 2004.
23. D. E. Chang, S. Loire, I. Mezi'c, J. Phys. D: Appl. Phys. 36, 3073 (2003).
24. Yang R J, Fu L M, Lin Y C, Electroosmotic flow in microchannels, JOURNAL OF COLLOID AND INTERFACE SCIENCE 239(1): 98-105 Jul. 1, 2001.
27. Squires T M, Bazant M Z, Induced-charge electro-osmosis, JOURNAL OF FLUID MECHANICS 509: 217-252 Jun. 25, 2004
28. J. Voldman, M. Toner, M. L. Gray, and M. A. Schmidt, Design and analysis of extruded quadrupolar dielectrophoretic traps, Journal of Electrostatics 57 (2003) 69-90

### CONCLUSION

In this invention, A software-driven device called the Microfluidic Central Processing Unit (μfCPU) is described. The device is a chamber encompassing a contiguous physical volume equipped with actuating equipment (electrodes, pressure membranes or other) capable of inducing physical forces on liquids, gases and particles contained in it, for the purpose of performing at least the 5 basic microfluidics operations: mixing, concentration, separation, transport and reaction within one integrated chamber. The device can have one volume where all of the operations are performed or can be spatially divided into several “processing areas” between which there are transport routes enabled by the software-regulated actuation.

In this invention, a device that contains more than one μfCPU employed in parallel or in series or both is described. The device has at least one central pump and possibly many integrated microfluidics pumps. Fluids and particles are transported from one of the μCPU units to another for processing. Each unit is controlled by a software program that specifies operations to be performed within that unit. The method of describing programs of the device at a high level is given. The method of describing programs of operation of the device at the level of frequencies, phases, duration times and voltage is given.

A Microfluidic Central Processing Unit in accordance with the present invention comprises a chamber, wherein the chamber comprises a plurality of electrodes within a contiguous physical volume, the chamber designed to accept at least one substance selected from the group consisting of liquids, gases, and particles within the chamber, a device, coupled to the plurality of electrodes within the chamber, and a computer, coupled to the device, wherein the computer controls signals used to actuate the plurality of electrodes within the chamber to exert at least one physical force on the substance in the chamber, the actuated electrodes performing at least mixing, concentration, separation, transport and reaction processes within the chamber.

Such a unit further optionally comprises the mixing, concentration, separation, transport and reaction processes being performed in sequence, the contiguous volume being spatially divided into a plurality of processing areas, a plurality of transport routes through the chamber for transporting a plurality of fluids between the plurality of processing areas, the Microfluidic Central Processing Unit being coupled to at least one other Microfluidic Central Processing Unit, the substance being delivered to the plurality of Microfluidic Central Processing Units by a central pump, the computer being further coupled directly to the chamber, and the computer detecting at least one of an optical, electrochemical, thermal, or mechanical reaction within the chamber of the Microfluidic Central Processing Unit.

Another unit in accordance with the present invention comprises chamber means for accepting at least one substance, the chamber means having a contiguous physical volume and comprising a plurality of electrodes within the contiguous physical volume, the at least one substance selected from the group consisting of liquids, gases, and particles within the chamber, device means, coupled to the plurality of electrodes within the chamber, for delivering electrical signals to the plurality of electrodes, and processing means, coupled to the device, for generating signals to control the device means delivery of electrical signals to the plurality of electrodes, wherein the plurality of electrodes exert at least one physical force on the substance in the chamber, the actuated electrodes performing at least mixing, concentration, separation, transport and reaction processes within the chamber.

Such a unit further optionally comprises the mixing, concentration, separation, transport and reaction processes being performed in sequence, the contiguous volume being spatially divided into a plurality of processing areas, a plurality of routing means through the chamber means for transporting a plurality of fluids between the plurality of processing areas, the Microfluidic Central Processing Unit being coupled to at least one other Microfluidic Central Processing Unit, the substance being delivered to the plurality of Microfluidic Central Processing Units by a central pump, the processing means being further coupled directly to the chamber means, and the processing means further comprises detection means for detecting at least one of an optical, electrochemical, thermal, or mechanical reaction within the chamber means.

It is intended that the scope of the invention be limited not by this detailed description, but rather by the claims appended hereto and the full range of equivalents of the claims. The above specification, examples and data provide a complete description of the manufacture and use of the composition of the invention. Since many embodiments of the invention can be made without departing from the spirit and scope of the invention, the invention resides in the claims hereinafter appended and the full range of equivalents thereof.

What is claimed is:

1. A Microfluidic Central Processing Unit, comprising:
a chamber, wherein the chamber comprises a plurality of electrodes within a contiguous physical volume, the chamber designed to accept at least one substance selected from the group consisting of liquids, gases, and particles within the chamber;
a device, coupled to the plurality of electrodes within the chamber; and
a computer, coupled to the device, wherein the computer controls signals used to actuate the plurality of electrodes within the chamber to exert at least one physical force on the substance in the chamber, the actuated electrodes performing at least mixing, concentration, separation, transport and reaction processes within the chamber.

2. The Microfluidic Central Processing Unit of claim 1, wherein the at least mixing, concentration, separation, transport and reaction processes are performed in sequence.

3. The Microfluidic Central Processing Unit of claim 1, wherein the contiguous volume is spatially divided into a plurality of processing areas.

4. The Microfluidic Central Processing Unit of claim 3, further comprising a plurality of transport routes through the chamber for transporting a plurality of fluids between the plurality of processing areas.

5. The Microfluidic Central Processing Unit of claim 1, wherein the Microfluidic Central Processing Unit is coupled to at least one other Microfluidic Central Processing Unit.

6. The Microfluidic Central Processing Unit of claim 5, wherein the substance is delivered to the plurality of Microfluidic Central Processing Units by a central pump.

7. The Microfluidic Central Processing Unit of claim 1, wherein the computer is further coupled directly to the chamber.

8. The Microfluidic Central Processing Unit of claim 7, wherein the computer detects at least one of an optical, electrochemical, thermal, or mechanical reaction within the chamber of the Microfluidic Central Processing Unit.

9. A Microfluidic Central Processing Unit, comprising:
chamber means for accepting at least one substance, the chamber means having a contiguous physical volume and comprising a plurality of electrodes within the contiguous physical volume, the at least one substance selected from the group consisting of liquids, gases, and particles within the chamber;
device means, coupled to the plurality of electrodes within the chamber, for delivering electrical signals to the plurality of electrodes; and
processing means, coupled to the device, for generating signals to control the device means delivery of electrical signals to the plurality of electrodes, wherein the plurality of electrodes exert at least one physical force on the substance in the chamber, the actuated electrodes performing at least mixing, concentration, separation, transport and reaction processes within the chamber.

10. The Microfluidic Central Processing Unit of claim 9, wherein the least mixing, concentration, separation, transport and reaction processes are performed in sequence.

11. The Microfluidic Central Processing Unit of claim 9, wherein the contiguous volume is spatially divided into a plurality of processing areas.

12. The Microfluidic Central Processing Unit of claim 11, further comprising a plurality of routing means through the chamber means for transporting a plurality of fluids between the plurality of processing areas.

13. The Microfluidic Central Processing Unit of claim 9, wherein the Microfluidic Central Processing Unit is coupled to at least one other Microfluidic Central Processing Unit.

14. The Microfluidic Central Processing Unit of claim 13, wherein the substance is delivered to the plurality of Microfluidic Central Processing Units by a central pump.

15. The Microfluidic Central Processing Unit of claim 9, wherein the processing means is further coupled directly to the chamber means.

16. The Microfluidic Central Processing Unit of claim 15, wherein the processing means further comprises detection means for detecting at least one of an optical, electrochemical, thermal, or mechanical reaction within the chamber means.
